(19) United States
(12) Patent Application Publication
(10) Pub. No.: US 2026/0080545 A1
(43) Pub. Date: Mar. 19, 2026

(54) Methods and systems for image segmentation

(71) Applicant: Canva Pty Ltd, Surry Hills (AU)

(72) Inventors: Jerome Vassilis Gerard NICOLAOU, Vienna (AT); Lingcong ZHAO, Vienna (AT); Valentin ZIATCHIN, Vienna (AT)

(73) Assignee: Canva Pty Ltd, Surry Hills (AU)

(21) Appl. No.: 19/177,837

(22) Filed: Apr. 14, 2025

(30) Foreign Application Priority Data
Apr. 24, 2024 (AU) 2024202707

(51) Int. Cl. G06T 7/194; G06T 5/73; G06T 7/11; G06T 7/12; G06T 11/00

(52) U.S. Cl. CPC G06T 7/194; G06T 5/73; G06T 7/11; G06T 7/12; G06T 11/00; G06T 2200/24; G06T 2207/20081; G06T 2207/20104; G06T 2207/20192

(57) ABSTRACT

Described embodiments generally relate to a method for extracting a portion of an image. The method includes accessing an image for editing; receiving at least one user input related to the accessed image, the at least one user input corresponding to at least one image element of the accessed image; based on the at least one user input, generating at least one new image mask; receiving a user input corresponding to at least one selected image mask; and generating an extraction mask based on each of the at least one selected image masks, to allow the portion of the image defined by the extraction mask to be extracted.

### CROSS-REFERENCE TO RELATED APPLICATIONS

This application is a U.S. Non-Provisional Application that claims priority to and the benefit of Australian Patent Application No. 2024202707, filed Apr. 24, 2024, that is hereby incorporated by reference in its entirety.

### TECHNICAL FIELD

Described embodiments relate to systems, methods and computer program products for performing image editing. In particular, described embodiments relate to systems, methods and computer program products for extracting image portions.

### BACKGROUND

Digital image editing processes can be used to produce a wide variety of modifications to digital images. For example, image elements such as foreground or background objects may be removed, replaced or extracted.

Traditional methods of extracting image elements include manually tracing around the image element to be extracted, which can be a long and tedious process, especially when complex image elements are being processed. Some automatic selection tools and background removal methods have been developed. However, these often produce undesirable results.

It is desired to address or ameliorate one or more shortcomings or disadvantages associated with prior systems and methods for performing image editing, or to at least provide a useful alternative thereto.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a method for extracting a portion of an image, the method comprising:
accessing an image for editing;
receiving at least one user input related to the accessed image, the at least one user input corresponding to at least one image element of the accessed image;
based on the at least one user input, generating at least one new image mask;
receiving a user input corresponding to at least one selected image mask; and
generating an extraction mask based on each of the at least one selected image masks, to allow the portion of the image defined by the extraction mask to be extracted.

Some embodiments further comprise adding the at least one new image mask to a set of image masks.

According to some embodiments, the at least one selected image mask corresponds to an image mask selected from the set of image masks.

Some embodiments further comprise presenting the user with the set of image masks for selection.

According to some embodiments, the set of image masks comprises at least one previously generated image mask.

According to some embodiments, the at least one new image mask was generated based on user input entered in a first selection mode, and the at least one previously generated image mask was generated based on user input entered in a second selection mode, and wherein the first selection mode is different from the second selection mode.

In some embodiments, the first selection mode is at least one of a text-based selection mode, a point based selection mode, or a bounding shape based selection mode.

According to some embodiments, the second selection mode is at least one of a text-based selection mode, a point based selection mode, or a bounding shape based selection mode.

Some embodiments further comprise applying the extraction mask to the accessed image to produce an output image.

Some embodiments further comprise refining the edges of each selected image mask.

Some embodiments further comprise refining the edges of the extraction mask.

According to some embodiments, refining the edges comprises generating a pixel-level precise mask.

In some embodiments, a matting model is used to generate the pixel-level precise mask.

In some embodiments, the refined mask includes non-binary values.

In some embodiments, generating the extraction mask comprises combining each of the at least two selected image masks.

According to some embodiments, combining each of the at least two selected image masks comprises generating an empty image mask and performing a logical OR operation between the empty image mask and each of the at least two selected image masks.

According to some embodiments, generating at least one new image mask comprises providing the accessed image and the at least one user input to a machine learning based segmentation tool.

In some embodiments, generating at least one new image mask comprises providing the accessed image and the at least one user input to a machine learning based object detection tool.

Some embodiments relate to a method for extracting a portion of an image, the method comprising:
accessing an image for editing;
receiving at least one first user input related to the accessed image, the at least one user input corresponding to at least one first image element of the accessed image;
based on the at least one first user input, generating at least one first image mask;
receiving at least one second user input related to the accessed image, the at least one second user input corresponding to at least one second image element of the accessed image;
based on the at least one first user input, generating at least one second image mask; and
generating an extraction mask based on each of the at least one first image mask and the at least one second image mask, to allow the portion of the image defined by the extraction mask to be extracted.

In some embodiments, the first user input is received in a first selection mode, and the second user input is received in a second selection mode, wherein the first selection mode is different from the second selection mode.

In some embodiments, the first selection mode is at least one of a text-based selection mode, a point based selection mode, or a bounding shape based selection mode.

According to some embodiments, the second selection mode is at least one of a text-based selection mode, a point based selection mode, or a bounding shape based selection mode.

Some embodiments further comprise applying the extraction mask to the accessed image to produce an output image.

Some embodiments further comprise refining the edges of the at least one first image mask.

Some embodiments further comprise refining the edges of the at least one second image mask.

Some embodiments further comprise refining the edges of the extraction mask.

Some embodiments further comprise refining the edges comprises generating a pixel-level precise mask.

In some embodiments, a matting model is used to generate the pixel-level precise mask.

According to some embodiments, the refined mask includes non-binary values.

According to some embodiments, generating the extraction mask comprises combining the at least one first image mask with the at least one second image mask.

In some embodiments, combining the at least one first image mask with the at least one second image mask comprises generating an empty image mask and performing a logical OR operation between the empty image mask, the at least one first image mask and the at least one second image mask.

In some embodiments, generating at least one new image mask comprises providing the accessed image and the at least one user input to a machine learning based segmentation tool.

In some embodiments, generating at least one new image mask comprises providing the accessed image and the at least one user input to a machine learning based object detection tool.

Some embodiments relate to a method for isolating a portion of an image, the method comprising:
accessing an image for editing;
presenting a user interface displaying at least one target selection option;
in response to an interaction with the at least one target selection option, activating a corresponding selection mode;
receiving at least one user input related to a selected portion of the accessed image, wherein the user input is corresponds with the activated selection mode;
determining at least one new image mask to apply to the accessed image based on the selected portion;
presenting a user interface option displaying the at least one new image mask; and
in response to an interaction with the displayed at least one image mask, producing an extraction image mask and applying the extraction image mask to the accessed image to produce an output image.

According to some embodiments, the user interface option displays at least one previously generated image mask.

According to some embodiments, the at least one new image mask was generated based on user input entered in a first selection mode, and the at least one previously generated image mask was generated based on user input entered in a second selection mode.

According to some embodiments, the first selection mode is at least one of a text-based selection mode, a point based selection mode, or a bounding shape based selection mode.

In some embodiments, the second selection mode is at least one of a text-based selection mode, a point based selection mode, or a bounding shape based selection mode, and is different to the first selection mode.

According to some embodiments, producing an extraction image mask comprises generating an empty image mask and performing a logical OR operation between the empty image mask and at least one selected image mask.

In some embodiments, determining at least one new image mask comprises providing the accessed image and the at least one user input to a machine learning based segmentation tool.

In some embodiments, determining at least one new image mask comprises providing the accessed image and the at least one user input to a machine learning based object detection tool.

Some embodiments relate to a non-transitory computer-readable storage medium storing instructions which, when executed by a processing device, cause the processing device to perform the method of some other embodiments.

Some embodiments relate to a computing device comprising:
the non-transitory computer-readable storage medium of some other embodiments; and
a processor configured to execute the instructions stored in the non-transitory computer-readable storage medium.

### BRIEF DESCRIPTION OF DRAWINGS

Various ones of the appended drawings merely illustrate example embodiments of the present disclosure and cannot be considered as limiting its scope.

FIG. 1A shows an example input image that may be processed in some embodiments;

FIG. 1B shows the image of FIG. 1A processed using a previously known technique;

FIG. 1C shows the image of FIG. 1A processed using an alternative previously known technique;

FIG. 1D shows the image of FIG. 1A processed using methods according to some described embodiments;

FIG. 2 shows a block diagram of an image processing system according to some embodiments;

FIG. 3 shows a flowchart of a method of image processing that may be performed by the system of FIG. 2 according to some embodiments;

FIG. 4A shows a flowchart of a first method of prompt-based mask generation that may be used by the system of FIG. 2 according to some embodiments;

FIG. 4B shows a flowchart of a second method of prompt-based mask generation that may be used by the system of FIG. 2 according to some embodiments;

FIG. 4C shows a flowchart of a third method of prompt-based mask generation that may be used by the system of FIG. 2 according to some embodiments;

FIG. 5 shows an example screenshot of an application for image editing executed by the system of FIG. 2 showing a first selection method according to some embodiments;

FIG. 6 shows an example screenshot of an application for image editing executed by the system of FIG. 2 showing objects selected using the first selection method according to some embodiments;

FIG. 7 shows an example screenshot of an application for image editing executed by the system of FIG. 2 showing a second selection method according to some embodiments;

FIG. 8 shows an example screenshot of an application for image editing executed by the system of FIG. 2 showing an object selected using the second selection method according to some embodiments;

FIG. 9 shows an example screenshot of an application for image editing executed by the system of FIG. 2 showing a third selection method according to some embodiments;

FIG. 10 shows an example screenshot of an application for image editing executed by the system of FIG. 2 showing an object selected using the third selection method according to some embodiments;

FIG. 11 shows an example screenshot of an application for image editing executed by the system of FIG. 2 showing multiple selected objects according to some embodiments;

FIG. 12A shows a first mask generated from the selected object as shown in FIG. 8 according to some embodiments;

FIG. 12B shows a second mask generated from the selected object as shown in FIG. 6 according to some embodiments;

FIG. 12C shows a combined mask generated based on the masks of FIGS. 12A and 12B according to some embodiments; and

FIG. 12D shows an example output image generated using the system of FIG. 2 according to some embodiments.

### DESCRIPTION OF EMBODIMENTS

Described embodiments relate to systems, methods and computer program products for performing image editing. In particular, described embodiments relate to systems, methods and computer program products for extracting image portions.

When performing image editing, it is sometimes desirable to extract one or more image elements from an image. This may be to create a new image with the extracted elements, to insert the extracted elements into a new image, to modify the position of the extracted elements within the original image, to apply colour styles or other editing to the extracted elements, or to perform an inpainting process on the extracted elements.

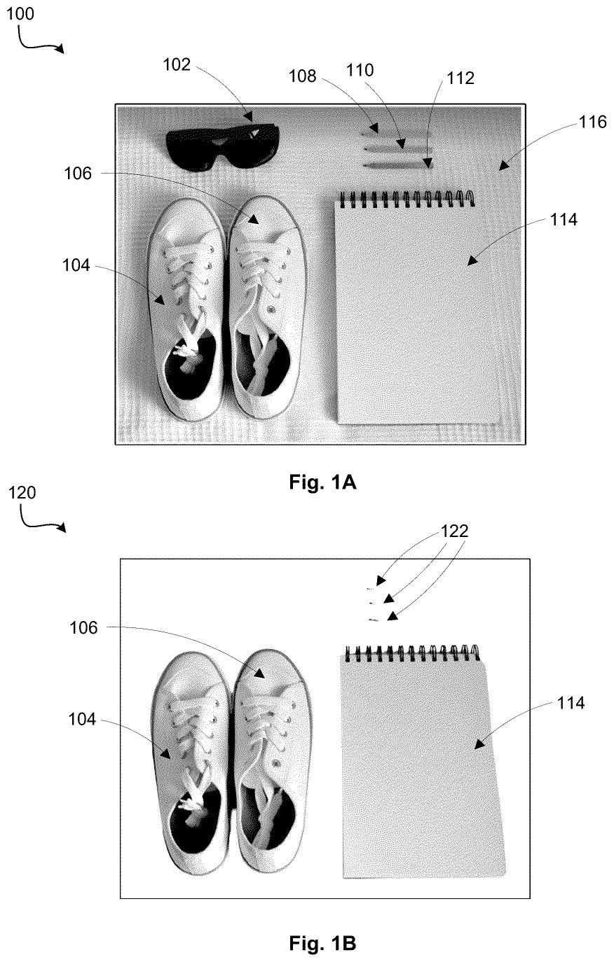

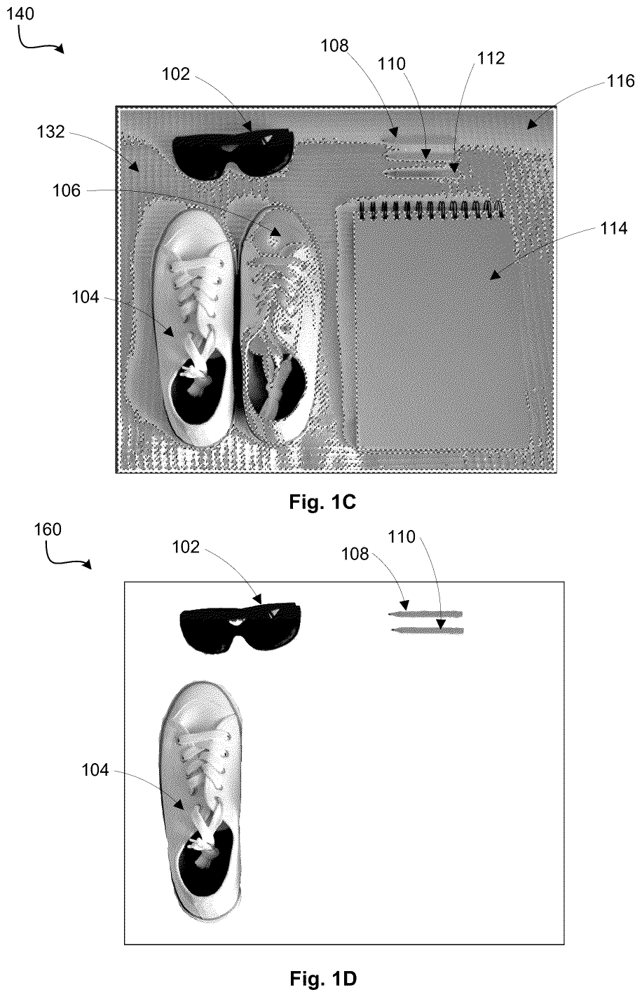

FIG. 1A shows an example of an input image 100 that a user may wish to edit by extracting one or more image elements. As illustrated, the image elements of image 100 include a pair of sunglasses 102, a left sneaker 104, a right sneaker 106, a top pencil 108, a middle pencil 110, a bottom pencil 112, a notepad 114 and a background 116.

One known method of extracting image elements from an input image is by performing a background removal process. However, automatic background removal processes are inflexible and can produce undesirable results, especially when an input image has multiple foreground elements or does not have an easily distinguishable background and foreground.

FIG. 1B shows an example output image 120 that has been obtained by processing input image 100 through an automatic background removal tool. Since the automatic background removal tool is designed to automatically determine foreground and background elements before removing the background, the user has no input into which elements are retained and which are removed. In the example output image 120, left shoe 104, right shoe 106 and notepad 114 have been extracted, while the remaining image elements have been removed. However, remnants 122 have been retained from pencils 108, 110 and 112. This is an undesirable result both because the user was unable to select specific elements for extraction, and because the extraction process has performed poorly on pencils 108, 110 and 112 by leaving only remnants of these image elements.

An alternative known approach of extracting image elements by user selection is through the use of magic wand type selection tool. Such tools select objects or regions of an image by selecting all of the pixels in proximity to a selected point whose colour or luminance are within a predetermined range of the selected point. However, such tools perform poorly when proximate image elements are similar in colour and luminance.

FIG. 1C shows an example image 140 showing a magic wand selection tool being used on input image 100, where a point on notepad 114 was selected. As much of the image is of a similar colour and luminance, the resultant selected area 132 spills out of notepad 114 and into background 116 as well as into right show 106.

Other known methods of image element extraction include lasso tools and image segmentation processes. Lasso tools can be used for freehand selection of image elements, but can be tedious and time-consuming, especially when complex image elements are being processed. Segmentation tools work by segmenting an image into many areas, but can produce rough results as well as being time consuming to use and difficult to scale.

Described embodiments relate to a new method of automatic image element extraction that provides users with the ability to target specific image elements or objects in an input image for extraction. Some embodiments allow multiple selection modes to be used to extract multiple image elements automatically. Some embodiments relate to methods of extracting image elements that can more accurately segment selected image portions such that the extracted image portion is of a higher quality and complex object edges, such as hair, are accurately extracted. Some embodiments relate to methods of extracting image elements that can be used to batch process many input images automatically, resulting in a more efficient image processing procedure for the user.

Described embodiments also provide an improved user interface experience for users, whereby multiple selection modes can be activated and iteratively used to select one or more target image elements in an image, and to extract a number of selected image elements and generate an output image in a single action. This is in contrast to previous methods, whereby image elements selected using different techniques would need to be extracted separately and later manually combined into a composite image.

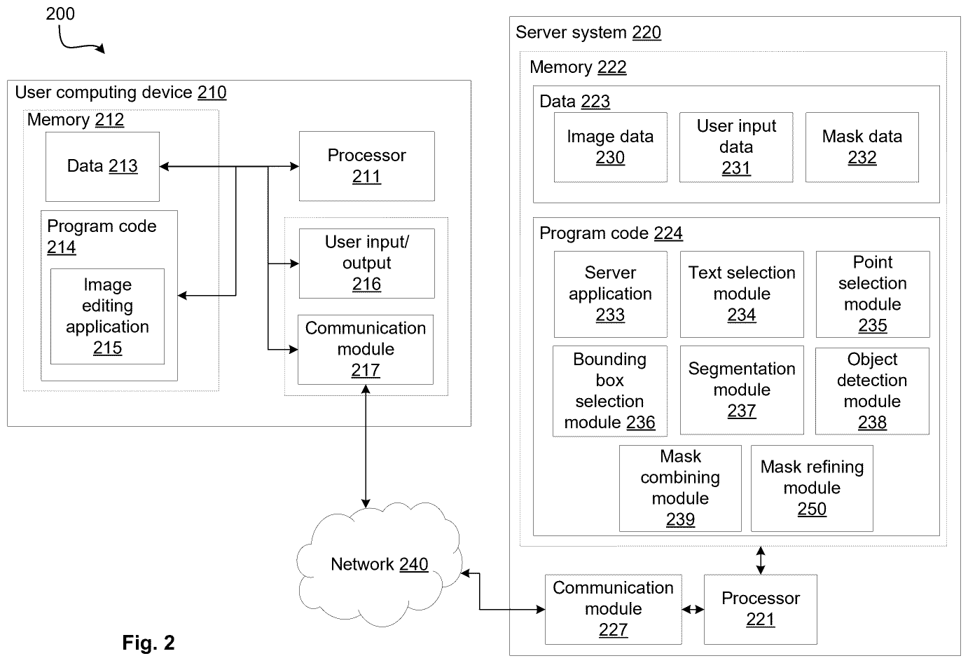

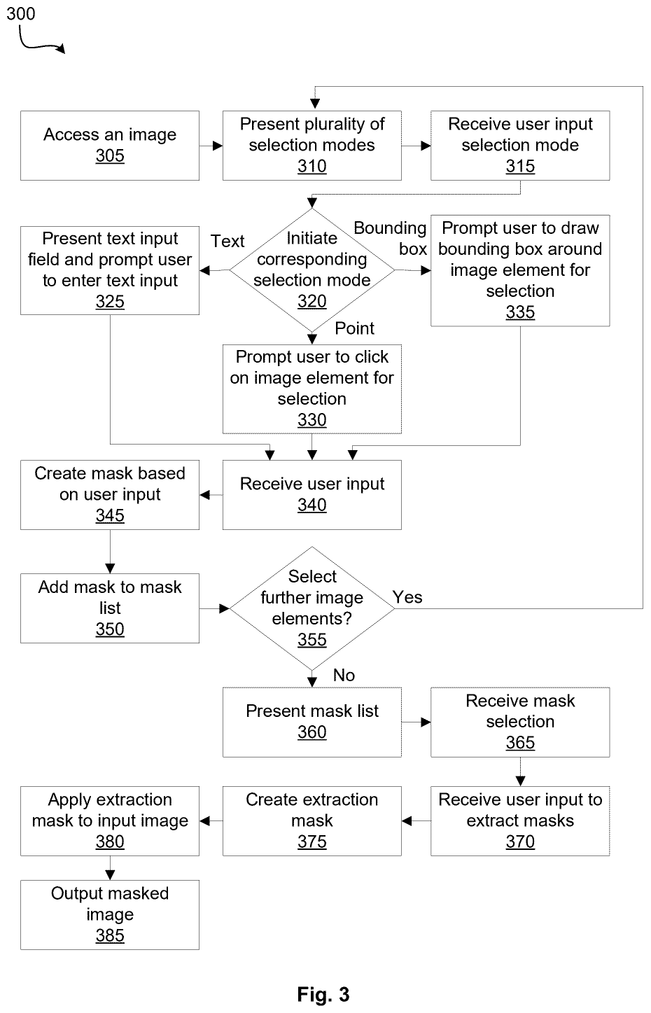

FIG. 1D shows an example output image 160 that may be obtained by the described methods and systems of some embodiments based on input image 100. As illustrated, image elements 102, 104, 108 and 110 have been selectively extracted, while the remaining image elements have been removed. Output image 160 may be obtainable by system 200 performing method 300, as described below with reference to FIGS. 2 and 3.

FIG. 2 is a block diagram showing an example system 200 that may be used to perform image element extraction techniques for image processing according to some described embodiments. System 200 comprises a user computing device 210 which may be controlled by a user wishing to edit one or more images, and specifically to extract image elements from one or more images. In the illustrated embodiment, system 200 further comprises a server system 220. User computing device 210 may be in communication with server system 220 via a network 240. However, in some embodiments, user computing device 210 may be configured to perform the described methods independently, without access to a network 230 or server system 240.

User computing device 210 may be a computing device such as a personal computer, laptop computer, desktop computer, tablet, or smart phone, for example. User computing device 210 comprises a processor 211 configured to read and execute program code. Processor 211 may include one or more data processors for executing instructions, and may include one or more of a microprocessor, microcontroller-based platform, a suitable integrated circuit, and one or more application-specific integrated circuits (ASICs).

User computing device 210 further comprises at least one memory 212. Memory 212 may include one or more memory storage locations which may include volatile and non-volatile memory, and may be in the form of ROM, RAM, flash or other memory types. Memory 212 may also comprise system memory, such as a BIOS.

Memory 212 is arranged to be accessible to processor 211, and to store data 213 that can be read from and written to by processor 211. Memory 212 may also contain program code 214 that is executable by processor 211, to cause processor 211 to perform various functions. For example, program code 214 may include an image editing application 215. Processor 211 executing image editing application 215 may be caused to perform aspects of image editing methods such as image element extraction, as described in further detail below with reference to FIG. 3.

According to some embodiments, image editing application 215 may be a web browser application (such as Chrome, Safari, Internet Explorer, Opera, or any other alternative web browser application) which may be configured to access web pages that provide image editing functionality via an appropriate uniform resource locator (URL).

Program code 214 may include additional applications that are not illustrated in FIG. 2, such as an operating system application, which may be a mobile operating system if user computing device 210 is a mobile device, a desktop operating system if user computing device 210 is a desktop device, or an alternative operating system.

User computing device 210 may further comprise user input and output peripherals 216. These may include one or more of a display screen, touch screen display, mouse, keyboard, speaker, microphone, and camera, for example. User I/O 216 may be used to receive data and instructions from a user, and to communicate information to a user.

User computing device 210 may further comprise a communication module 217, to facilitate communication between user computing device 210 and other remote or external devices. Communication module 217 may allow for wired or wireless communication between user computing device 210 and external devices, and may use Wi-Fi, USB, Bluetooth, or other communications protocols. According to some embodiments, communication module 217 may facilitate communication between user computing device 210 and server system 220 via a network 240, for example.

Network 240 may comprise one or more local area networks or wide area networks that facilitate communication between elements of system 200. For example, according to some embodiments, network 240 may be the internet. However, network 240 may comprise at least a portion of any one or more networks having one or more nodes that transmit, receive, forward, generate, buffer, store, route, switch, process, or a combination thereof, etc. one or more messages, packets, signals, some combination thereof, or so forth. Network 240 may include, for example, one or more of: a wireless network, a wired network, an internet, an intranet, a public network, a packet-switched network, a circuit-switched network, an ad hoc network, an infrastructure network, a public-switched telephone network (PSTN), a cable network, a cellular network, a satellite network, a fibre-optic network, or some combination thereof.

Server system 220 may comprise one or more computing devices and/or server devices (not shown), such as one or more servers, databases, and/or processing devices in communication over a network, with the computing and/or server devices hosting one or more application programs, libraries, APIs or other software elements. The components of server system 220 may provide server-side functionality to one or more client applications, such as image editing application 215. The server-side functionality may include operations such as user account management, login, and content creation functions such as image editing, saving, publishing, and sharing functions. According to some embodiments, server system 220 may comprise a cloud based server system. While a single server system 220 is shown, server system 220 may comprise multiple systems of servers, databases, and/or processing devices. Server system 220 may host one or more components of a platform for performing image editing according to some described embodiments.

Server system 220 may comprise at least one processor 221 and a memory 222. Processor 221 may include one or more data processors for executing instructions, and may include one or more of a microprocessor, microcontroller-based platform, a suitable integrated circuit, and one or more application-specific integrated circuits (ASIC's). Memory 222 may include one or more memory storage locations, and may be in the form of ROM, RAM, flash or other memory types.

Memory 222 is arranged to be accessible to processor 221, and to contain data 223 that processor 221 is configured to read from and write to. Data 223 may store data such as user account data, image data, and data relating to image editing tools, such as machine learning models trained to perform image editing functions.

In the illustrated embodiment, data 223 comprises image data 230, user input data 231 and mask data 232. While these are illustrated as residing in memory 222 of server system 220, in some embodiments some or all of this data may alternatively or additionally reside in memory 212 of user computing device 210, or in an alternative local or remote memory location.

Image data 230 may store image data relating to an image to be edited by image editing application 215. Image data 230 may be received from user computing device 210 executing image editing application 215 in response to a user selecting or uploading an image to be edited. For example, referring to the examples shown in FIGS. 1A and 5, images 100 and/or 510 may be stored in image data 230. Image data 230 may additionally or alternatively store image data relating to images that are in the process of being edited, or final edited images.

User input data 231 may be received from user computing device 210 in response to a user entering responding to a prompt while executing image editing application 215, in order to perform an image editing function. User input data may comprise one or more text based prompts and/or one or more coordinates of the input image, and may be used to identify one or more target image elements for extraction. Examples of user input data are described in further detail below, and illustrated in FIGS. 5, 7 and 9.

Mask data 232 may be generated by user computing device 210 and/or server system 220 based on image data 230 and user input data 231, as described in further detail below with reference to method 300 of FIG. 3. Mask data 232 may be used to perform image editing techniques including image element extraction, background removal, image element editing, inpainting, or other image processing techniques.

Mask data 232 may comprise image data, which may be binary image data. For example, each mask stored in mask data 232 may comprise a binary image consisting of zero and non-zero values. Non-zero values may correspond to a region of interest or image element to be extracted, while the zero values may correspond to the background or the area to be ignored or removed.

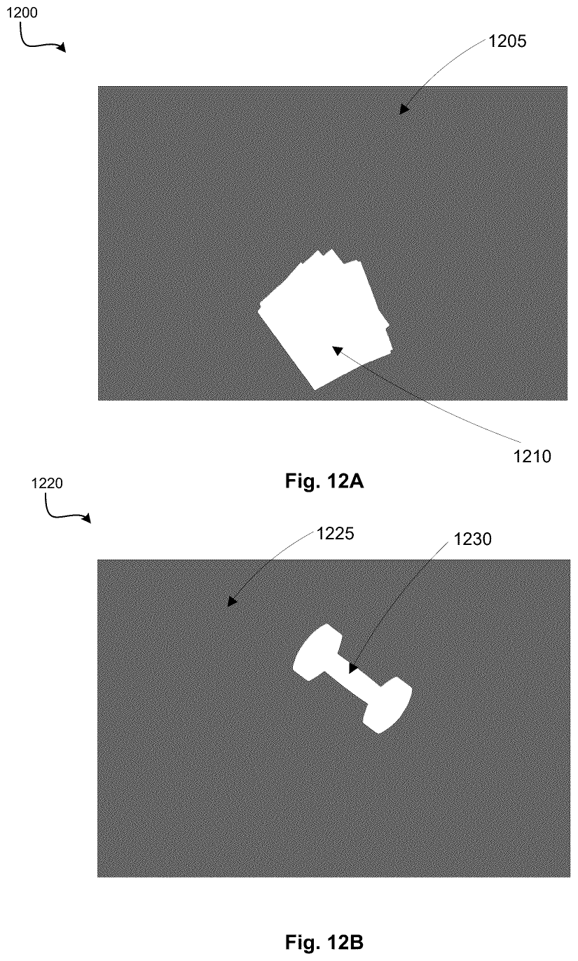

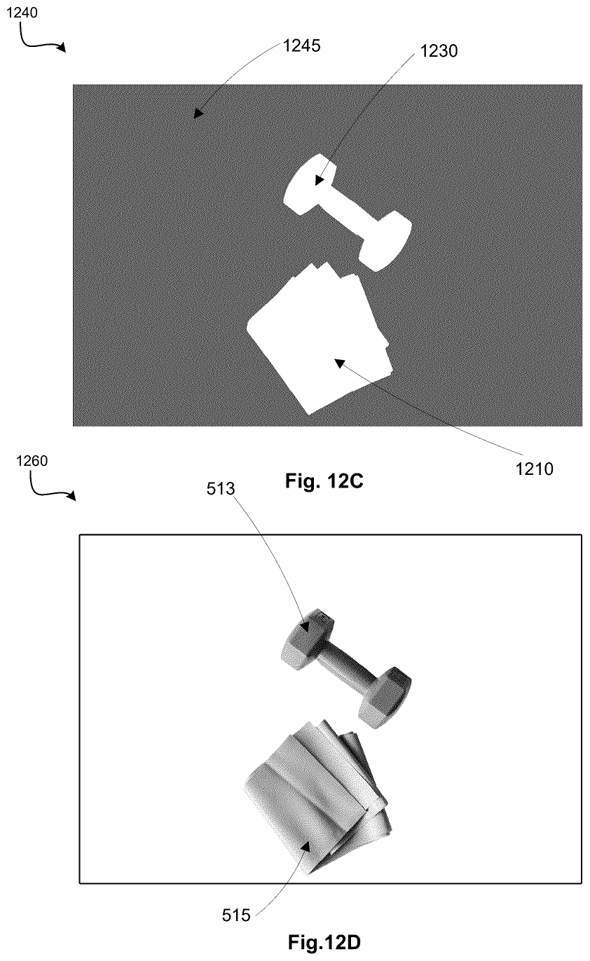

Examples of masks that may be stored in mask data are shown in FIGS. 12A, 12B and 12C, and are described in further detail below with reference to those images.

Memory 222 further comprises program code 224 that is executable by processor 221, to cause processor 221 to execute workflows. For example, program code 224 may comprise a server application 233 executable by processor 221 to cause server system 220 to perform server-side functions. According to some embodiments, such as where image editing application 215 is a web browser, server application 233 may comprise a web server such as Apache, IIS, NGINX, GWS, or an alternative web server. In some embodiments, the server application 233 may comprise an application server configured specifically to interact with image editing application 215. Server system 220 may be provided with both web server and application server modules.

Program code 224 may also comprise one or more code modules, such as one or more of a text selection module 234, a point selection module 235, a bounding box election module 236, a segmentation module 237, an object detection module 238, a mask combining module 239 and a mask refining module 250.

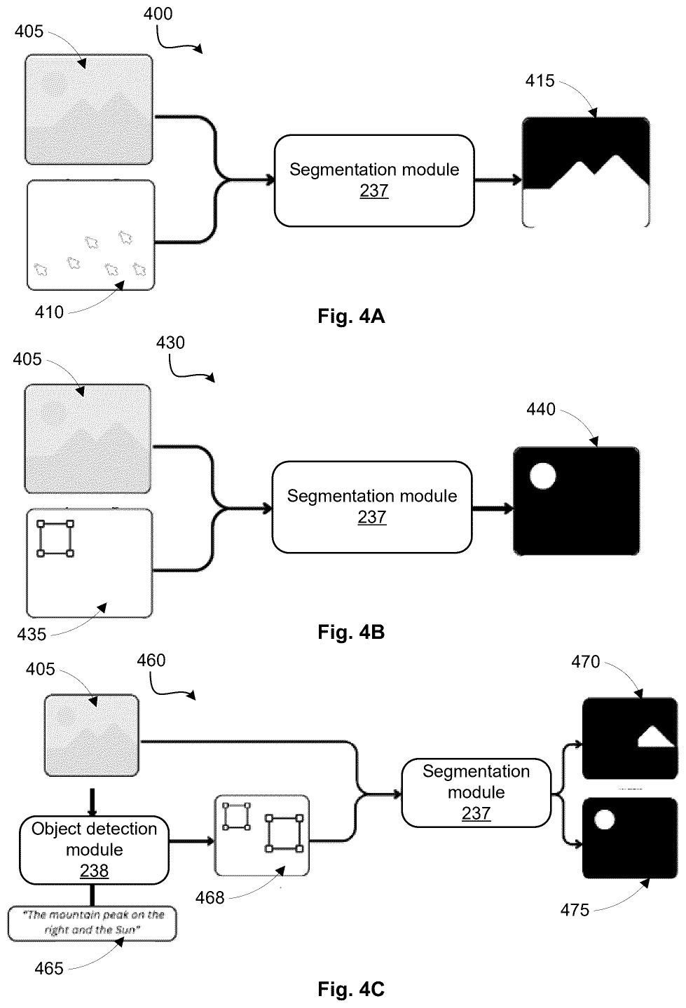

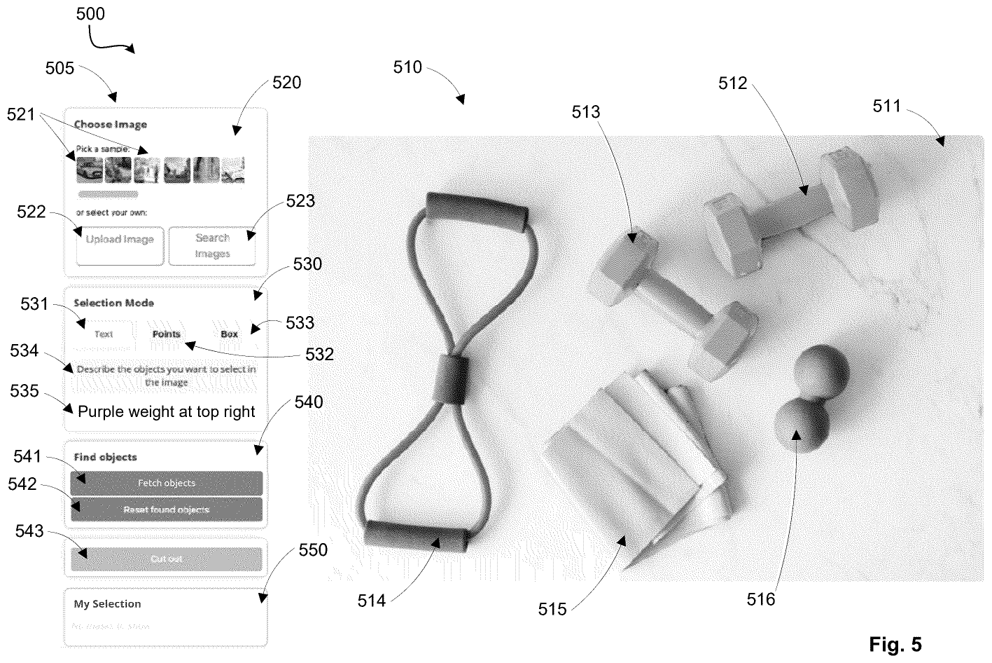

As described in further detail below with reference to step 325 of method 300, executing text selection module 234 may cause processor 221 to present the user with means to enter a text-based prompt in order to identify one or more target image elements in an input image. Executing text selection module 234 may further cause processor 221 to perform a mask generation method using the identified target image elements, as described in further detail below with reference to FIGS. 3 and 4A.

As described in further detail below with reference to step 330 of method 300, executing point selection module 235 may cause processor 221 to present the user with means to select one or more points of an input image in order to identify one or more target image elements in the input image. Executing point selection module 235 may further cause processor 221 to perform a mask generation method using the identified target image elements, as described in further detail below with reference to FIGS. 3 and 4B.

As described in further detail below with reference to step 335 of method 300, executing bounding box selection module 236 may cause processor 221 to present the user with means to draw a bounding box on an input image in order to identify one or more target image elements in the input image. Executing bounding box selection module 236 may further cause processor 221 to perform a mask generation method using the identified target image elements, as described in further detail below with reference to FIGS. 3 and 4C.

As described in further detail below with reference to step 345 of method 300, executing segmentation module 237 may cause processor 221 to perform a segmentation process on an input image based on one or more target image elements in order to generate a mask, which may be stored in mask data 232.

As described in further detail below with reference to FIG. 4C, executing object detection module 238 may cause processor 221 to identify one or more target objects in an input image based in a received text prompt.

As described in further detail below with reference to step 375 of method 300, executing mask combining module 239 may cause processor 221 to combine one or more masks to produce a composite mask or extraction mask. The masks to be combined may be retrieved from mask data 232 based on masks selected by a user, and the composite mask or extraction mask may be stored to mask data 232 and used for further image processing techniques, such as for extracting image elements from an input image.

As described in further detail below with reference to step 375 of method 300, executing mask refining module 250 may cause processor 221 to refine one or more masks, which may include refining one or more extraction mask. The masks to be refined may be retrieved from mask data 232 based on masks selected by a user or masks generated by processor 211 or processor 221.

Text selection module 234, point selection module 235, bounding box election module 236, segmentation module 237, object detection module 238, mask combining module 239 and mask refining module 250 may be software modules such as add-ons or plug-ins that operate in conjunction with the image editing application 215 to expand the functionality thereof. In alternative embodiments, modules 234, 235, 236, 237, 238, 239 and/or 250 may be native to the image editing application 215. In still further alternative embodiments, modules 234, 235, 236, 237, 238, 239 and/or 250 may be a stand-alone applications (running on user computing device 210, server system 220, or an alternative server system (not shown)) which communicate with the image editing application 215, such as over network 240.

Modules 234, 235, 236, 237, 238, 239 and 250 have been described and illustrated as being part of/installed on the server system 220. In some embodiments, modules 234, 235, 236, 237, 238, 239 and/or 250 may be configured as an add-on or extension to server application 233, a separate, stand-alone server application that communicates with server application 233, or a native part of server application 233. Inputs, such as input images and user inputs, may be provided and/or received at/by the user computing device 210, and then transferred to server system 220, such that the prompt-based editing method may be performed by the components of the server system 220.

In some alternative embodiments (not shown), the functionality provided by one or more of modules 234, 235, 236, 237, 238, 239 and/or 250 could alternatively be provided by user computing device 210, based on locally or remotely stored image data 230, user input data 231 and/or mask data 232. One or more of modules 234, 235, 236, 237, 238, 239 and/or 250 may reside as an add-on or extension to image editing application 215, a separate, stand-alone application that communicates with image editing application 215, or a native part of image editing application 215.

In alternate embodiments (not shown), all functions, including receiving the prompt, user selected area and image, may be performed by the server system 220. Or, in some embodiments, an application programming interface (API) may be used to interface with the server system 220 for performing the presently disclosed image element extraction and image editing techniques.

Server system 220 may also comprise a communications module 227, to facilitate communication between server system 220 and other remote or external devices. Communications module 227 may allow for wired or wireless communication between server system 220 and external devices, and may use Wi-Fi, USB, Bluetooth, or other communications protocols. According to some embodiments, communications module 227 may facilitate communication between server system 220 and user computing device 210, for example.

Server system 220 may include additional functional components to those illustrated and described, such as one or more firewalls (and/or other network security components), load balancers (for managing access to the server application 233), and or other components.

FIG. 3 is a process flow diagram of a method 300 of performing an image editing technique according to some embodiments. In some embodiments, method 300 may be performed at least partially by processor 211 of user computing device 210 executing image editing application 215. In some embodiments, method 300 may be performed at least partially by processor 221 of server system 220 executing server application 233. While certain steps of method 300 have been described as being executed by particular elements of system 200, these steps may be performed by different elements in some embodiments. Furthermore, while the steps of method 300 have been illustrated and described as occurring in a particular order, some of the steps may be performed in an alternative order without affecting the outcome of the method.

At step 305, processor 221 executing server application 233 is caused to access an image for editing. This image will be referred to as the “input image”. In some embodiments, the input image may be a user-selected image. According to some embodiments, a number of images may be selected for batch-processing, and may be accessed simultaneously or in succession.

The accessing may be from a memory location such as from image data 230, from a user I/O, or from an external device such as user computing device 210 in some embodiments. For example, according to some embodiments, the input image may be selected and/or generated by a user via user computing device 210 executing image editing application 215, and forwarded by communication module 217 from user computing device 210 to server system 220 via network 240. The input image may be received by communication module 227 of server system 220 and stored in image data 230 for accessing by processor 221. The input image may be displayed via user input/output 216 of user computing device 210 executing image editing application 215.

At step 310, processor 221 executing server application 233 causes a plurality of selection modes to be presented to a user via user computing device 210 executing image editing application 215. Server system 220 may send instructions to user computing device 210 via communication module 227 to cause user computing device 210 to display the selection modes via user input/output 216. Alternatively, user computing device 210 may be caused to display the selection modes when executing image editing application 215, without needing instruction from server system 220.

An example of the selection modes that may be displayed is shown in FIG. 5 and described in further detail below with respect to selection mode box 530. In some embodiments, the selection modes may include a text selection mode, a point selection mode and/or a bounding box selection mode.

At step 315, processor 221 executing server application 233 receives user input indicative of a desired input selection mode. The user input may be received by user input/output 216 in response to the selection modes displayed at step 310, and sent by communication module 217 to server system 220 via network 240. According to some embodiments, the user input may correspond to one of a text selection mode, a point selection mode or a bounding box selection mode.

At step 320, processor 221 executing server application 233 causes user computing device 210 to initiate a selection mode corresponding to the user input received at step 315. In other words, user computing device 210 may be caused to initiate one of a text selection mode, a point selection mode or a bounding box selection mode. Server system 220 may send instructions to user computing device 210 via communication module 227 to cause user computing device 210 to initiate the selection mode corresponding to the user input received at step 315. Alternatively, user computing device 210 may be caused to initiate the selection mode corresponding to the user input received at step 315 when executing image editing application 215, without needing instruction from server system 220.

If a text selection mode was selected by the user at step 315 and initiated at step 320, then at step 325, processor 221 executing server application 233 is caused to execute text selection module 234. Processor 221 executing text selection module 234 causes user computing device 210 executing image editing application 215 to present a text input field to the user via user input/output 216. For example, user computing device 210 may be caused to present a text box via user input/output 216. In some embodiments, server application 233 may further cause user computing device 210 to prompt the user of user computing device 210 to enter a text input via the presented text input field corresponding to one or more target image elements. Server system 220 may send instructions to user computing device 210 via communication module 227 to cause user computing device 210 to present the text input field. Alternatively, user computing device 210 may be caused to present the text input field in response to receiving user input at step 340 when executing image editing application 215, without needing instruction from server system 220.

If a point selection mode was selected by the user at step 315 and initiated at step 320, then at step 330, processor 221 executing server application 233 is caused to execute point selection module 235. Processor 221 executing point selection module 235 causes user computing device 210 executing image editing application 215 to prompt the user of user computing device 210 to select one or more points on the input image as displayed via user input/output 216 to identify the target image element. This may be by clicking, pressing or tapping on the displayed input image, for example. Server system 220 may send instructions to user computing device 210 via communication module 227 to cause user computing device 210 to present the prompt. Alternatively, user computing device 210 may be caused to present the prompt in response to receiving user input at step 340 when executing image editing application 215, without needing instruction from server system 220.

If a bounding box selection mode was selected by the user at step 315 and initiated at step 320, then at step 335, processor 221 executing server application 233 is caused to execute bounding box selection module 236. Processor 221 executing bounding box selection module 236 causes user computing device 210 executing image editing application 215 to prompt the user of user computing device 210 to draw a bounding box around the target image element on the input image as displayed via user input/output 216. This may be by clicking, pressing or tapping on at least two points of the displayed input image so as to define a bounding shape, or by clicking and dragging to position and size a bounding shape on the displayed input image, for example. The bounding shape may be a square, rectangle, circle, oval, or other shape. Server system 220 may send instructions to user computing device 210 via communication module 227 to cause user computing device 210 to present the prompt. Alternatively, user computing device 210 may be caused to present the prompt in response to receiving user input at step 340 when executing image editing application 215, without needing instruction from server system 220.

At step 340, processor 221 executing server application 233 receives user input based on the selection mode from user computing device 210 via communication module 227. The user input may corresponding to one or more target image elements. The received user input may be stored in user input data 231. According to some embodiments, the user input may be generated by a user interacting with user input/output 216 of user computing device 210 executing image editing application 215.

Where a text selection mode was initiated at step 320, the received user input may comprise a text string entered by the user via user input/output 216 in a displayed text input field. The text string may comprise natural language describing one or more target image elements. For example, for input image 100, the text string may be “sunglasses” where the target image element is sunglasses 102. Where multiple similar image elements are present, the text string may be more descriptive. For example, for input image 100, the text string may be “the top pencil” where the target image element is top pencil 108.

A further example text string is shown in FIG. 5 and described below with reference to text input field 535.

Where a point selection mode was initiated at step 320, the received user input may comprise one or more coordinates corresponding to areas of the input image as selected by the user via user input/output 216. In some embodiments, the user input may comprise a single coordinate of the input image. In some embodiments, the user input may comprise two or more coordinates.

A point-based user input is shown in FIG. 7 and described below with reference to points 705.

Where a bounding box selection mode was initiated at step 320, the received user input may comprise one or more coordinates defining a bounding shape of the input image as defined by the user via user input/output 216. In some embodiments, the user input may comprise two coordinates of the input image defining a bounding shape. In some embodiments, the user input may comprise two or more coordinates defining a bounding shape.

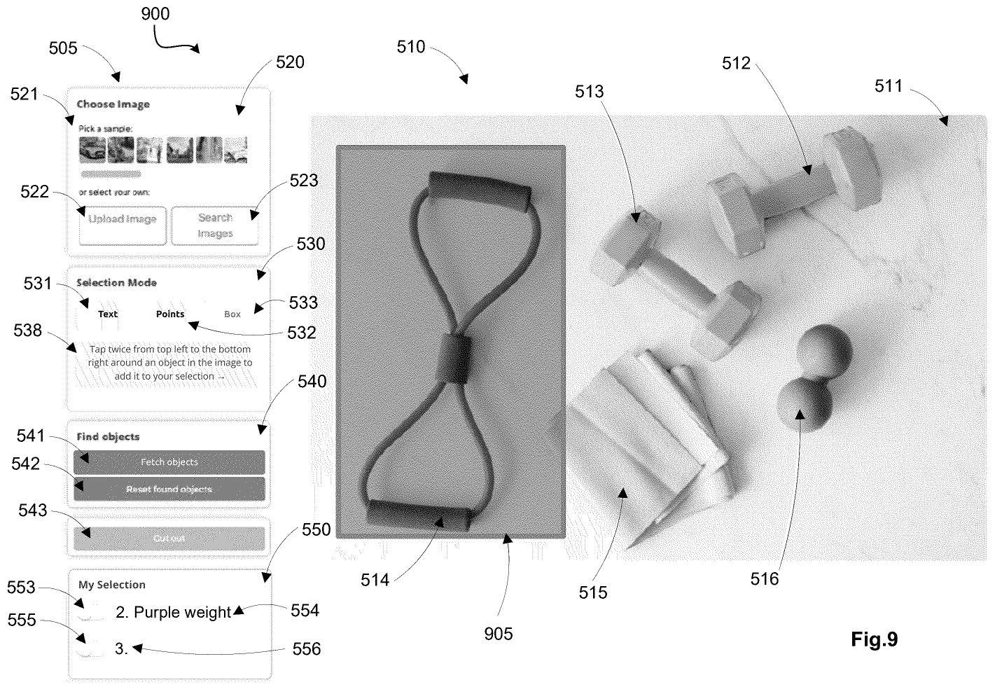

A bounding box user input is shown in FIG. 9 and described below with reference to bounding box 905.

At step 345, processor 221 executing server application 233 is caused to identify one or more target image elements of the input image based on the user input received at step 340, and to generate one or more masks based on the identified target image elements. According to some embodiments, a separate mask may be generated for each identified target image element. Where a number of images were accessed at step 205 for batch processing, a separate mask may be generated for each identified target element across each accessed image. The user input data may be retrieved from user input data 231. Some example methods for identifying target image elements and generating masks based on text, point and bounding box inputs are described below with reference to FIGS. 4A, 4B and 4C. Processor 221 may be caused to execute segmentation module 237 and/or object detection module 238 to identifying target image elements and generating one or more corresponding masks. Processor 221 may be caused to store the generated masks in mask data 232.

At step 350, processor 221 executing server application 233 is caused to add the masks created at step 345 to a mask list, or to a group or set of image masks. This mask list, group or set may be stored in mask data 232, and may comprise any masks generated with respect to the input image. This may include previously generated masks, which may have been generated using any of the selection modes described above with reference to steps 325, 330 or 335, for example. Where batch processing is being performed, the mask list may list each mask in each image separately. Alternatively, similar or corresponding masks generated across multiple images may be listed as a single entry.

At step 355, processor 221 executing server application 233 is caused to determine whether further image elements are to be selected. According to some embodiments, the user may indicate whether or not they wish to select further target image elements by interacting with one or more user interface elements. In some embodiments, processor 221 may determine that the user wishes to select further target image elements unless the user indicates that they have finished selecting image elements, which may be by interacting with one or more user interface elements.

If processor 221 determines that further image elements are to be selected, processor 221 executing server application 233 is caused to return to step 310 and cause user computing device 210 to present the selection modes to the user for further selection. In some embodiments, the selection modes may be shown or available to the user throughout method 300, or until the user indicates that all target image elements have been identified.

If processor 221 determines that no further image elements are to be selected, processor 221 executing server application 233 is caused to continue to step 360, and to cause user computing device to present a mask list to the user for selection. In some embodiments, the mask list may be shown to the user or available to the user throughout method 300. The mask list may comprise a list of selectable elements each corresponding to a mask previously generated at step 345. The mask list may be retrieved from mask data 232. Each mask may be represented by an identifier, which may be an alpha-numeric identifier in some embodiments. In some embodiments, each mask may be consecutively numbered with a numeric identifier. Where a mask was generated based on a text prompt, the identifier may comprise the text prompt.

Each mask presented in the mask list may be selected, or toggled between a selected and unselected state. In some embodiments, each mask in the mask list may be associated with a visual element indicating whether or not the mask is currently selected. In some embodiments, the area of the input image corresponding to each mask may be presented in an altered form to indicate whether a corresponding mask is selected or unselected. For example, where a mask is selected, an area of the displayed input image corresponding to the selected mask may be displayed in a different colour, with a border or outline, with an overlay or pattern, or otherwise visually altered. Examples of mask lists are shown in FIGS. 5 to 11 and described in further detail below with reference to mask selection box 550.

At step 365, processor 221 executing server application 233 is caused to receive a mask selection from the user based on the masks presented in the mask list at step 360. The mask selection may correspond to one or more masks in the mask list that the user selects by interacting with the user interface element corresponding to the mask.

At step 370, processor 221 executing server application 233 is caused to receive user input indicating that the user wishes to extract the image elements corresponding to the selected masks. For example, the user may interact with a user interface element corresponding to an “extract” or “cut out” function. An example of such a user interface element is shown in FIGS. 5 to 11 and described in further detail below with reference to cut out button 543.

At step 375, processor 221 executing server application 233 is caused to create an extraction mask based on the one or more selected masks as received at step 365. Where batch processing is being performed, an extraction mask may be created for each individual image being processed.

In some embodiments, creating an extraction mask may comprise combining one or more selected masks. Processor 221 may be caused to retrieve mask data 232 corresponding to masks identified by the user input received at 365, and execute mask combining module 239 to combine the retrieved masks into a composite mask. The composite mask may be stored as the extraction mask. Combining masks may comprise initialising a composite mask by creating a blank mask with the same dimensions as the input image, and then adding each retrieved mask to the composite mask. If the retrieved masks are not the same size as the composite mask, processor 221 may be caused to resize them to the same dimensions as the composite mask before adding them to the composite mask.

Where the masks comprise binary image data where non-zero values indicate the target image element and zero values indicate areas of the image that are not the target image element, the process of adding masks to the composite mask may comprise performing a logical “OR” function between the composite mask and each retrieved mask. Where the masks comprise binary image data where zero values indicate the target image element and non-zero values indicate areas of the image that are not the target image element, the process of adding masks to the composite mask may comprise performing a logical “AND” function between the composite mask and each retrieved mask.

According to some embodiments, performing step 375 may additionally or alternatively comprise refining the one or more masks originally generated as described above with respect to step 345. This may be performed by processor 221 executing mask refining module 250. In some cases, the one or more originally generated masks may be refined before being combined into a composite mask, as described above.

Refining the masks may include fine-tuning the detection process and refining the edges of the mask to generate a pixel-level precise mask or edge precise mask for each mask selected at step 365. This process may improve the capture of complex edges, such as hair, in selected objects.

According to some embodiments, a background removal tool such as the remove. bg tool provided by Canva™ may be used to perform this refining step. The background removal tool may receive an image and a rough mask as an input, and be configured to output a more accurate mask. The tool may use a segmentation model such as a matting model to generate a pixel-level precise mask or an edge precise mask.

According to some embodiments, the refined masks generated at step 375 may have values in a range, such as ([0.0,1.0]), rather than only binary values. In other words, the refined masks may comprise non-binary values. This may allow for a softer and more natural transition between the masked and non-masked areas. Where the refined masks have values in a range as described above, the generated composite or extraction mask may also have values in a range.

In some embodiments, the refining process described above may be performed on the generated composite mask after combining the retrieved masks into a composite mask. The refined mask may be stored as the extraction mask.

The generated extraction mask may be stored to mask data 232. In some embodiments, method 300 may finish at step 375 once an extraction mask has been generated. A user may be able to use the extraction mask to perform further image editing steps, such as by performing image element extraction, background removal, image element editing, inpainting, or other image processing techniques on the input image using the extraction mask.

In some embodiments, where the extraction mask is being used to generate a new image consisting of only the target image elements, processor 221 may proceed to step 380. At step 380, processor 221 executing server application 233 is caused to apply the extraction mask generated at step 380 to the input image accessed at step 305 to generate an output image. Where batch processing is being performed, a separately generated extraction mask may be applied to each accessed image to generate multiple output images.

At step 385, processor 221 executing server application 233 is caused to output the output image generated at step 380. This may be by storing the output image to data 223, outputting it to user computing device 210 for display to the user and/or for storing in data 213, and/or by sending the output image to an alternative external computing device via network 240.

FIG. 4A shows a flowchart of an example method 400 of generating a mask based on user input entered using a point selection mode. Method 400 may be performed as part of step 345 of method 300.

An input image 405 is accessed as described above with respect to step 305 of method 300, or retrieved from image data 230. User input 410 in the form of a number of coordinates selected by the user is received as described above with reference to step 340 of method 300, or retrieved from user input data 231.

Segmentation module 237 is executed based on the input image 405 and user input 410. According to some embodiments, executing segmentation module 237 may comprise performing a segmentation technique, which may be a machine learning based segmentation technique in some embodiments. For example, some embodiments may use the “predict” or “generate” methods of the Segment Anything Model developed by Meta AI Research to perform the segmentation process. The Segment Anything Model can be configured to generate masks based on an input image and a list of two-dimensional coordinates, which may be generated based on the user input 410.

Alternatively, a different segmentation technique may be used to generate the mask.

The output mask 415 is stored in mask data 232. In the illustrated embodiment, the output mask 415 corresponds to the mountains pictured in input image 405.

FIG. 4B shows an example flowchart 430 of generating a mask based on user input entered using a bounding box selection mode. Method 400 may be performed as part of step 345 of method 300.

An input image 405 is accessed as described above with respect to step 305 of method 300, or retrieved from image data 230. User input 435 in the form of coordinates defining a bounding shape drawn by the user is received as described above with reference to step 340 of method 300, or retrieved from user input data 231.

Segmentation module 237 is executed based on the input image 405 and user input 435. According to some embodiments, executing segmentation module 237 may comprise performing a segmentation technique, which may be a machine learning based segmentation technique in some embodiments. For example, some embodiments may use the “predict” or “generate” methods of the Segment Anything Model developed by Meta AI Research to perform the segmentation process. The Segment Anything Model can be configured to generate masks based on an input image and a bounding box defined by two coordinates defining the upper-left and lower-right of the box, which may be generated based on the user input 410.

Alternatively, a different segmentation technique may be used to generate the mask.

The output mask 440 is stored in mask data 232. In the illustrated embodiment, the output mask 440 corresponds to the sun pictured in input image 405.

FIG. 4C shows an example flowchart 460 of generating a mask based on user input entered using a text selection mode. Method 400 may be performed as part of step 345 of method 300.

An input image 405 is accessed as described above with respect to step 305 of method 300, or retrieved from image data 230. User input 465 in the form of input text is received as described above with reference to step 340 of method 300, or retrieved from user input data 231. In the illustrated embodiment, the input text reads “the mountain peak on the right and the sun”.

Object detecting module 238 is executed based on the input image 405 and user input 465. According to some embodiments, executing object detecting module 238 may comprise performing an object detect technique, which may be a machine learning based technique to identify image elements based on a text prompt in some embodiments. For example, some embodiments may use the Grounding DINO tool for object detection, which may be configured to generate bounding boxes 468 based on an input image and a text prompt, wherein the bounding boxes map to the image elements described by the text prompt.

Alternatively, a different object detection technique may be used to generate points or bounding boxes defining the image elements.

The output bounding boxes 468 are used as input for segmentation module 237.

Segmentation module 237 is executed based on the input image 405 and bounding boxes 468. According to some embodiments, executing segmentation module 237 may comprise performing a segmentation technique, which may be a machine learning based segmentation technique in some embodiments. For example, some embodiments may use the “predict” or “generate” methods of the Segment Anything Model developed by Meta AI Research to perform the segmentation process. The Segment Anything Model can be configured to generate masks based on an input image and bounding boxes defined by two coordinates defining the upper-left and lower-right of the boxes, which may be generated based on the bounding boxes 468.

Alternatively, a different segmentation technique may be used to generate the masks.

The output masks 470 and 475 are stored in mask data 232. In the illustrated embodiment, the output mask 470 corresponds to the mountain peak on the right and the output mask 475 corresponds to the sun pictured in input image 405.

FIG. 5 shows an example screenshot 500 that may be displayed on user input/output 216 of user computing device 210 when executing image editing application 215. Specifically, screenshot 500 may be displayed at step 340 of method 300, where user input has been received in a text selection mode.

Screenshot 500 includes a tool panel 505 and a displayed input image 510.

Tool panel 505 includes an image selection box 520, a selection mode box 530, a find object box 540, a cut out button 543 and a mask selection box 550.

Image selection box 520 includes tools allowing a user to select an input image for editing. In the illustrated embodiment, image selection box 520 includes a number of images 521 for selection, an upload image button 522 and a search images button 523. Upload image button 522 may allow a user to upload an input image for editing, and search images button 523 may allow a user to search for an input image for editing.

Once an input image is selected for editing via image selection box 520, the input image may be displayed as input image 510.

Selection mode box 530 includes a number of selection modes that a user can choose to use to identify target image elements. In the illustrated embodiment, selection mode box 530 includes a text selection mode button 531, a points selection mode button 532 and a box selection mode button 533. A user can interact with the buttons to select a desired selection mode. In the illustrated embodiment, the text selection mode button 531 is selected.

Selection mode box 530 also includes a prompt 534 and a text input field 535. The prompt reads “describe the objects you want to select in the image” and the text input field has entered text reading “Purple weight at top right”.

Find objects box 540 includes a fetch objects button 541 and a reset found objects button 542. A user may interact with fetch objects button 541 when they would like to cause image elements corresponding to the entered text to be identified. A user may interact with reset found objects button 542 when they would like to cause identified image elements to be reset.

Cut out button 543 may allow a user to extract or cut out selected image elements from the input image 510. The image elements to be cut out may be those indicated as selected within mask selection box 550. As mask selection box 550 is empty in the illustrated embodiment, cut out button 543 is disabled.

Mask selection box 550 may display the list of masks available for selection by a user. As no masks have been generated, in the illustrated embodiment mask selection box 550 is empty.

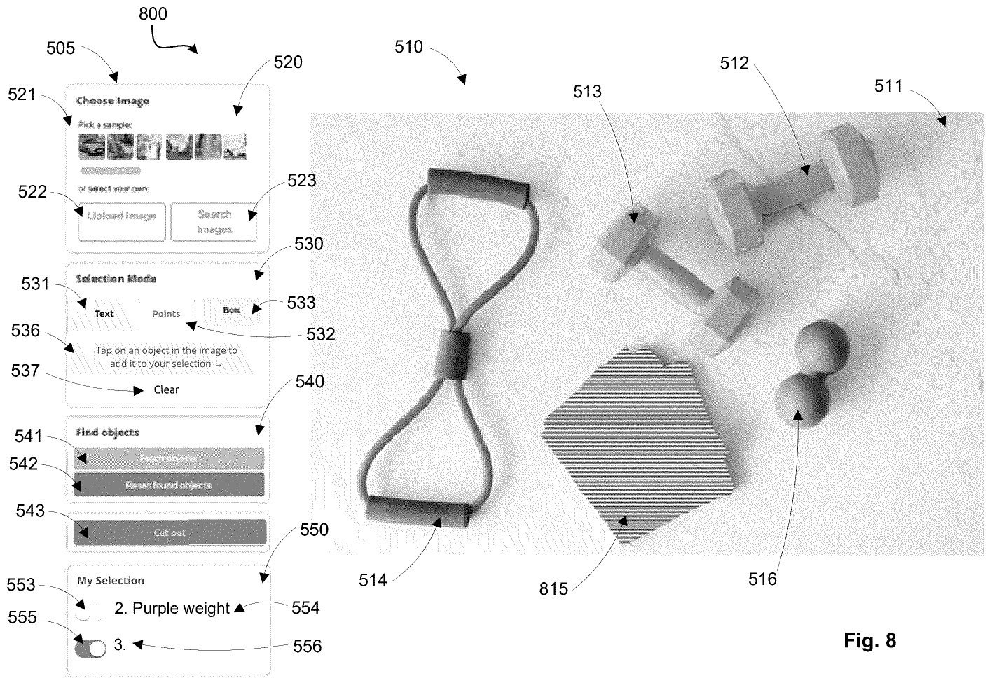

Input image 510 corresponds to an image selected by a user for editing, and comprises a number of image elements. These include a marbled background 511, purple weights 512 and 513, a red FIG. 8 resistance band 514, an aqua resistance band 515, and a blue peanut massage ball 516. As input image 510 includes two purple weights 512 and 513 both in the top right of the image, the prompt entered at text input field 535 could correspond to either weight.

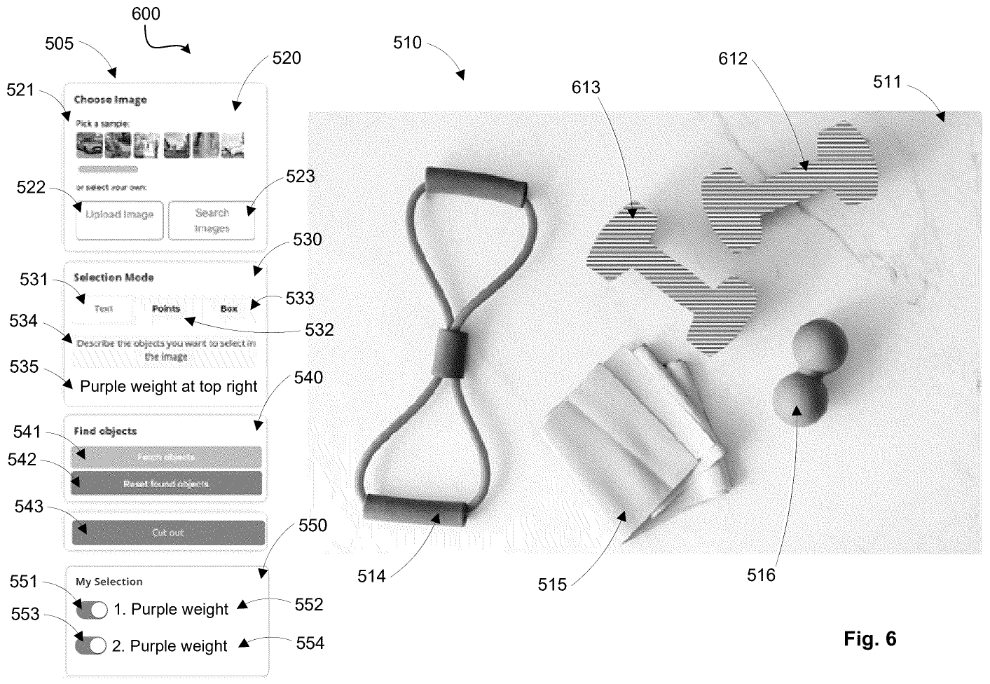

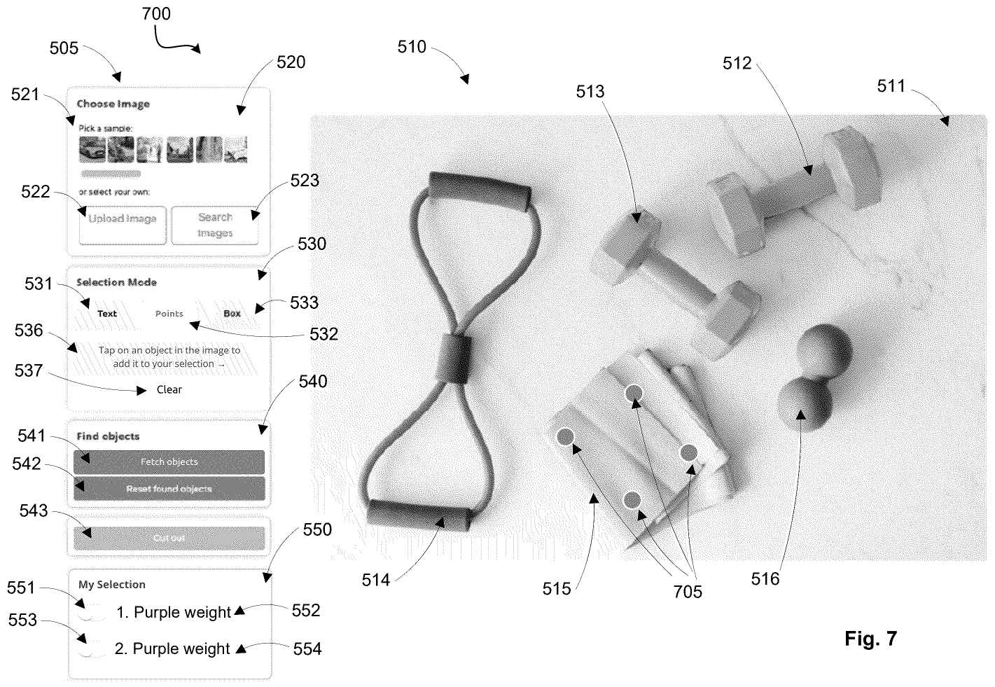

FIG. 6 shows an example screenshot of an application for image editing executed by the system of FIG. 2 showing objects selected using the first selection method according to some embodiments;

FIG. 6 shows an example screenshot 600 that may be displayed on user input/output 216 of user computing device 210 when executing image editing application 215. Specifically, screenshot 600 may be displayed at step 350 of method 300, where a mask has been generated and added to a mask list. This may occur once a user interacts with the fetch objects button as shown in screenshot 500.

Screenshot 600 includes a tool panel 505 and a displayed input image 510, as in screenshot 500. As described above, tool panel 505 includes an image selection box 520, a selection mode box 530, a find object box 540, a cut out button 543 and a mask selection box 550.

As described above, image selection box 520 includes tools allowing a user to select an input image for editing, including a number of images 521 for selection, an upload image button 522 and a search images button 523. Selection mode box 530 includes a text selection mode button 531, a points selection mode button 532 and a box selection mode button 533, with the text selection mode button 531 selected. Selection mode box 530 also includes a prompt 534 and a text input field 535.

Find objects box 540 includes a fetch objects button 541 and a reset found objects button 542. However, as objects have already been fetched based on the prompt entered in text input field 535, the fetch objects button 541 is disabled.

Mask selection box 550 now displays two masks generated based on the received text prompt. The first mask has a selection identifier 551 which shows the mask as selected, and a mask identifier 552 which reads “1. Purple weight”. The second mask has a selection identifier 553 which shows the mask as selected, and a mask identifier 554 which reads “2. Purple weight”.

As there is at least one selected mask, cut out button 543 is now active.

Input image 510 shows the selected masks 612 and 613, corresponding to purple weights 512 and 513. As input image 510 includes two purple weights 512 and 513 both in the top right of the image, the prompt entered at text input field 535 has been identified as corresponding to each weight, and a separate mask has been generated for each weight. The masks are overlaid with a pattern to visually distinguish them from the other image elements of image 510.

FIG. 7 shows an example screenshot 700 that may be displayed on user input/output 216 of user computing device 210 when executing image editing application 215. Specifically, screenshot 700 may be displayed at step 340 of method 300, where user input has been received in a point selection mode.

Screenshot 700 includes a tool panel 505 and a displayed input image 510, as in screenshot 500. As described above, tool panel 505 includes an image selection box 520, a selection mode box 530, a find object box 540, a cut out button 543 and a mask selection box 550.

As described above, image selection box 520 includes tools allowing a user to select an input image for editing, including a number of images 521 for selection, an upload image button 522 and a search images button 523. Selection mode box 530 includes a text selection mode button 531, a points selection mode button 532 and a box selection mode button 533.

In screenshot 700, the points selection mode button 532 is selected. Selection mode box 530 also includes a prompt 534 and a clear button 537. Prompt 534 reads “tap on an object in the image to add it to your selection”. Clear button 537 can be used to clear previously entered taps.

Find objects box 540 includes a fetch objects button 541 and a reset found objects button 542. As a new selection mode has been selected and new user input has been entered, the fetch objects button 541 is enabled.

Mask selection box 550 displays the two masks generated as shown in screenshot 600, but selection identifiers 551 and 553 indicate that the masks are not selected. As there is not at least one selected mask, cut out button 543 is now disabled.

Input image 510 shows a number of input points 705 which have been placed over aqua resistance band 515.

FIG. 8 shows an example screenshot 800 that may be displayed on user input/output 216 of user computing device 210 when executing image editing application 215. Specifically, screenshot 800 may be displayed at step 350 of method 300, where a mask has been generated and added to a mask list. This may occur once a user interacts with the fetch objects button as shown in screenshot 700.

Screenshot 800 includes a tool panel 505 and a displayed input image 510, as in screenshot 500. As described above, tool panel 505 includes an image selection box 520, a selection mode box 530, a find object box 540, a cut out button 543 and a mask selection box 550.

As described above, image selection box 520 includes tools allowing a user to select an input image for editing, including a number of images 521 for selection, an upload image button 522 and a search images button 523. Selection mode box 530 includes a text selection mode button 531, a points selection mode button 532 and a box selection mode button 533, with the points selection mode button 532 selected. Selection mode box 530 also includes a prompt 534 and a clear button 537.

Find objects box 540 includes a fetch objects button 541 and a reset found objects button 542. However, as objects have already been fetched based on the prompt entered by way of input points 705, the fetch objects button 541 is disabled.

Mask selection box 550 now displays previously generated mask 554 and a new mask generated based on the received input points 705. The new mask has a selection identifier 555 which shows the mask as selected, and a mask identifier 556 which reads “3.”

As there is at least one selected mask, cut out button 543 is now active.

Input image 510 shows the selected mask 815, corresponding to aqua resistance band 515. The mask is overlaid with a pattern to visually distinguish it from the other image elements of image 510.

FIG. 9 shows an example screenshot 900 that may be displayed on user input/output 216 of user computing device 210 when executing image editing application 215. Specifically, screenshot 900 may be displayed at step 340 of method 300, where user input has been received in a box selection mode.

Screenshot 900 includes a tool panel 505 and a displayed input image 510, as in screenshot 500. As described above, tool panel 505 includes an image selection box 520, a selection mode box 530, a find object box 540, a cut out button 543 and a mask selection box 550.

As described above, image selection box 520 includes tools allowing a user to select an input image for editing, including a number of images 521 for selection, an upload image button 522 and a search images button 523. Selection mode box 530 includes a text selection mode button 531, a points selection mode button 532 and a box selection mode button 533.

In screenshot 900, the box selection mode button 533 is selected. Selection mode box 530 also includes a prompt 538. Prompt 534 reads “tap twice from top left to the bottom right around an object in the image to add it to your selection”.

Find objects box 540 includes a fetch objects button 541 and a reset found objects button 542. As a new selection mode has been selected and new user input has been entered, the fetch objects button 541 is enabled.

Mask selection box 550 displays the two masks generated as shown in screenshot 800, but selection identifiers 553 and 555 indicate that the masks are not selected. As there is not at least one selected mask, cut out button 543 is now disabled.

Input image 510 shows an input box 905 which has been placed over red FIG. 8 resistance band 514.

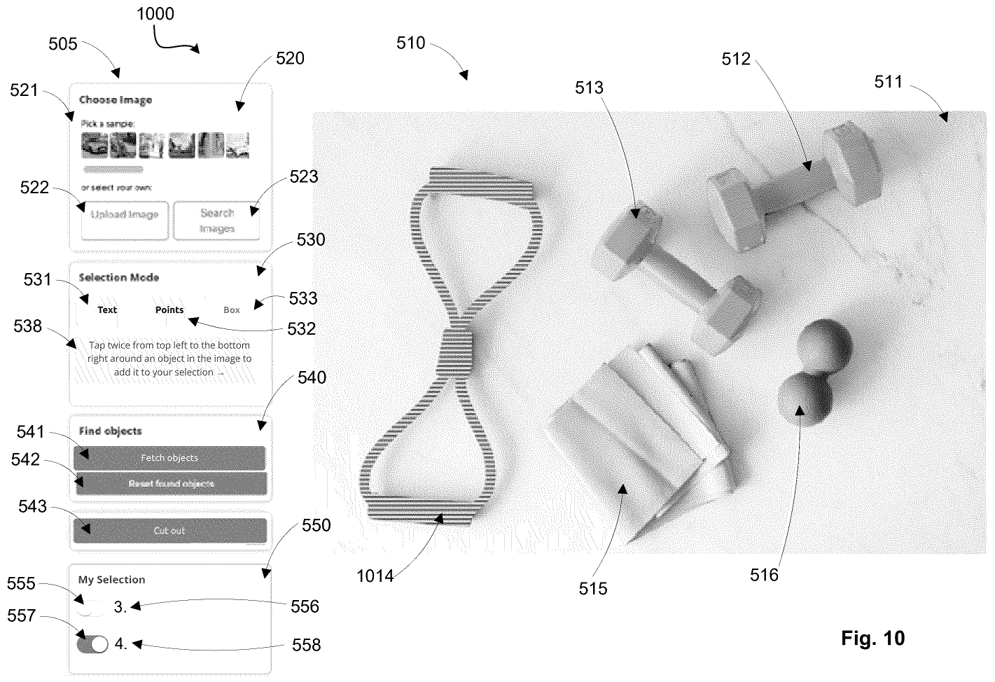

FIG. 10 shows an example screenshot 1000 that may be displayed on user input/output 216 of user computing device 210 when executing image editing application 215. Specifically, screenshot 1000 may be displayed at step 350 of method 300, where a mask has been generated and added to a mask list. This may occur once a user interacts with the fetch objects button as shown in screenshot 900.

Screenshot 1000 includes a tool panel 505 and a displayed input image 510, as in screenshot 500. As described above, tool panel 505 includes an image selection box 520, a selection mode box 530, a find object box 540, a cut out button 543 and a mask selection box 550.

As described above, image selection box 520 includes tools allowing a user to select an input image for editing, including a number of images 521 for selection, an upload image button 522 and a search images button 523. Selection mode box 530 includes a text selection mode button 531, a points selection mode button 532 and a box selection mode button 533, with the box selection mode button 533 selected. Selection mode box 530 also includes a prompt 538.

Find objects box 540 includes a fetch objects button 541 and a reset found objects button 542. However, as objects have already been fetched based on the prompt entered by way of input box 905, the fetch objects button 541 is disabled.

Mask selection box 550 now displays previously generated mask 556 and a new mask generated based on the received input box 905. The new mask has a selection identifier 557 which shows the mask as selected, and a mask identifier 558 which reads “4.”

As there is at least one selected mask, cut out button 543 is now active.

Input image 510 shows the selected mask 1014, corresponding to red FIG. 8 resistance band 514. The mask is overlaid with a pattern to visually distinguish it from the other image elements of image 510.

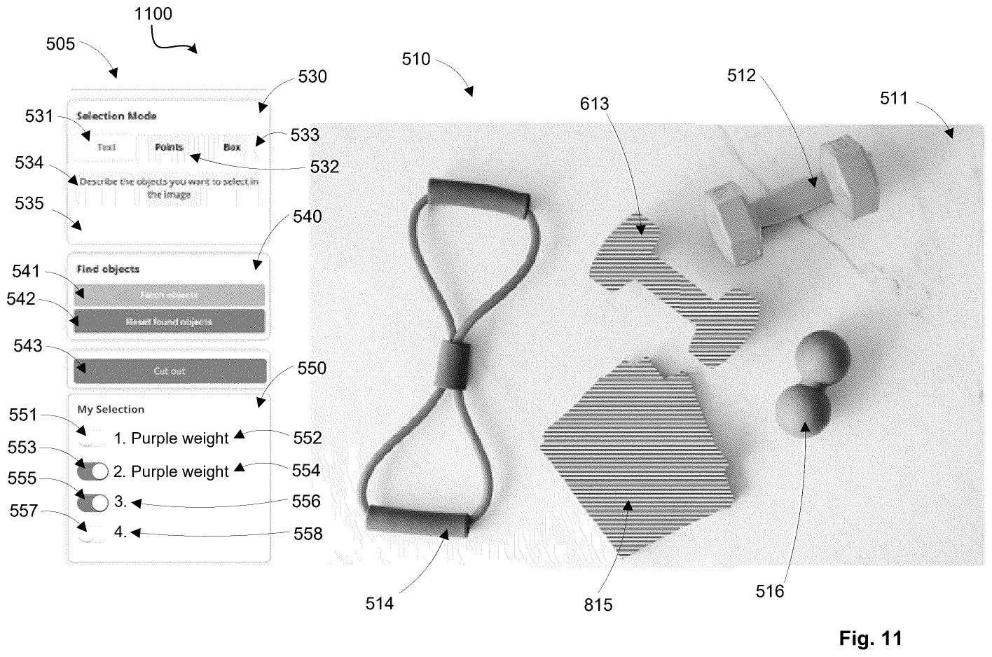

FIG. 11 shows an example screenshot 1100 that may be displayed on user input/output 216 of user computing device 210 when executing image editing application 215. Specifically, screenshot 1000 may be displayed at step 365 of method 300, where a mask list has been presented to a user to allow for a mask selection to be entered.

Screenshot 1100 includes a tool panel 505 and a displayed input image 510, as in screenshot 500. Tool panel 505 shows selection mode box 530, find object box 540, cut out button 543 and a mask selection box 550.

As described above, selection mode box 530 includes a text selection mode button 531, a points selection mode button 532 and a box selection mode button 533. In this case, the text selection mode button 531 selected.

Find objects box 540 includes a fetch objects button 541 and a reset found objects button 542. However, as objects have already been fetched, the fetch objects button 541 is disabled.

Mask selection box 550 now displays all previously generated masks 552, 554, 556 and 558. Masks 554 and 556 are selected, as show by selection identifiers 553 and 555.

As there is at least one selected mask, cut out button 543 is now active.

Input image 510 shows the selected masks 613 and 815, corresponding to purple weight 513 and aqua resistance band 515. The masks are overlaid with a pattern to visually distinguish them from the other image elements of image 510.

At this stage, interacting with cut out button 543 would cause an output image to be generated based on the selected masks, as described below with reference to FIGS. 12A to 12D.

FIG. 12A shows a first mask 1200 generated based on selected mask 815 as shown in FIG. 11. First mask 1200 includes a region of interest or target area 1210 corresponding to the aqua resistance band 515, and a background 1205.

FIG. 12B shows a second mask 1220 generated based on selected mask 613 as shown in FIG. 11. Second mask 1220 includes a region of interest or target area 1230 corresponding to purple weight 513, and a background 1225.

FIG. 12C shows a composite mask 1240 generated by combining first mask 1200 with second mask 1220, such as by performing a logical “OR” between the first mask 1200 and the second mask 1220. Composite mask 1240 includes a first target area 1210 corresponding to the aqua resistance band 515, a second target area 1230 corresponding to purple weight 513, and a background 1245. Composite mask 1240 may be generated at step 375 of method 300, as described above.

FIG. 12D shows an output image 1260. Output image 1260 consists of only purple weight 513 and aqua resistance band 515, as selected by the user in screenshot 1100. Output image 1260 may be generated by applying the composite mask 1240 to the input image 510. Output image 1260 may be generated at step 380 of method 300, as described above.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for extracting a portion of an image, the method comprising:
accessing an image for editing;
receiving at least one first user selection of at least one image element of the accessed image;
based on the at least one first user selection, generating at least one new image mask;
receiving a second user selection of two or more image masks, wherein at least one of the two or more image masks selected is an image mask of the at least one new image mask;
generating an extraction mask based on each of the two or more image masks selected; and
applying the extraction mask to the accessed image to extract the portion of the image defined by the extraction mask from the accessed image to produce an output image.

2. The method of claim 1, further comprising adding the at least one new image mask to a set of image masks.

3. The method of claim 2, further comprising presenting the user with the set of image masks for selection.

4. The method of claim 2, wherein the set of image masks comprises at least one previously generated image mask.

5. The method of claim 2, wherein the at least one new image mask was generated based on user input entered in a first selection mode, and the at least one previously generated image mask was generated based on user input entered in a second selection mode, and wherein the first selection mode is different from the second selection mode.

6. The method of claim 5, wherein at least one of the first and second selection modes is at least one of a text-based selection mode, a point based selection mode, or a bounding shape based selection mode.

7. The method of claim 1, further comprising refining the edges of each selected image mask.

8. The method of claim 1, further comprising refining the edges of the extraction mask.

9. The method of claim 8, wherein refining the edges comprises processing the mask to be refined using a background removal tool.

10. The method of claim 9, wherein the background removal tool is configured to receive the accessed image and the mask to be refined as inputs, and is configured to output a refined mask.

11. The method of claim 9, wherein the background removal tool is remove. bg.

12. The method of clam 8, wherein refining the edges comprises generating a pixel-level precise mask.

13. The method of claim 12, wherein a matting model is used to generate the pixel-level precise mask.

14. The method of claim 8, wherein the refined mask includes non-binary values.

15. The method of claim 1, wherein generating the extraction mask comprises combining each of the at least two selected image masks.

16. The method of claim 15, wherein combining each of the at least two selected image masks comprises generating an empty image mask and performing a logical OR operation between the empty image mask and each of the at least two selected image masks.

17. The method of claim 1, wherein generating at least one new image mask comprises providing the accessed image and the at least one user input to a machine learning based segmentation tool.

18. The method of claims 1, wherein generating at least one new image mask comprises providing the accessed image and the at least one user input to a machine learning based object detection tool.

19. A non-transitory computer-readable storage medium storing instructions which, when executed by a processing device, cause the processing device to perform a method for extracting a portion of an image, the method comprising:
accessing an image for editing;
receiving at least one first user selection of at least one image element of the accessed image;
based on the at least one first user selection, generating at least one new image mask;
receiving a second user selection of two or more at least one selected image masks, wherein at least one of the two or more image masks selected is an image mask of the at least one new image mask; and
generating an extraction mask based on each of the two or more image masks selected; and
applying the extraction mask to the accessed image to extract the portion of the image defined by the extraction mask from the accessed image to produce an output image.

20. A computing device comprising:
the non-transitory computer-readable storage medium of claim 19; and
a processor configured to execute the instructions stored in the non-transitory computer-readable storage medium.
